(19) United States
(12) Patent Application Publication
(10) Pub. No.: US 2024/0165617 A1
(43) Pub. Date: May 23, 2024

(54) MICROFLUIDIC DEVICE CHANNEL EXPANSION

(71) Applicant: Hewlett-Packard Development Company, L.P., Spring, TX (US)

(72) Inventors: Erik D. TORNIANEN, Corvallis, OR (US); Carson DENISON, Corvallis, OR (US); Richard W. SEAVER, Corvallis, OR (US); Anand Samuel JEBAKUMAR, Corvallis, OR (US); Pavel KORNILOVICH, Corvallis, OR (US); Alexander GOVYADINOV, Corvallis, OR (US)

(73) Assignee: Hewlett-Packard Development Company, L.P., Spring, TX (US)

(21) Appl. No.: 18/550,353

(22) PCT Filed: Apr. 6, 2021
(86) PCT No.: PCT/US2021/025889

§ 371 Date: Sep. 13, 2023

(51) Int. Cl. B01L 3/00

(52) U.S. Cl. CPC B01L 3/50273; B01L 2300/0877; B01L 2400/0406

(57) ABSTRACT

A microfluidic device includes a first channel having a first width and a second channel having a second width greater than the first width. The microfluidic device includes a transition channel having a first end fluidically connected to the first channel and a second end fluidically connected to the second channel. The transition channel expands in width from the first width to the second width so as to promote fluid flow from the first channel to the second channel.

### BACKGROUND

Microfluidic devices leverage the physical and chemical properties of liquids and gases at a small scale, such as at a sub-millimeter scale. Microfluidic devices geometrically constrain fluids to precisely control and manipulate the fluids for a wide variety of different applications. Such applications can include digital microfluidic (DMF) and DNA applications, single cell applications, as well as applications as varied as lab-on-a-chip, inkjet, microreactors, electrophoresis, capacitance sensing, fluidic heat sink, and fluidic sensor probe applications, among other applications.

### BRIEF DESCRIPTION OF THE DRAWINGS

FIGS. 1A and 1B are cross-sectional top view and front view diagrams, respectively, of an example microfluidic device with linear channel expansion that promotes fluid flow.

FIG. 2 is an example channel expansion angle graph for non-linear channel expansion that promotes fluid flow while minimizing channel length.

FIGS. 3A and 3B are cross-sectional top view diagrams of example microfluidic devices with non-linear channel expansion that promotes fluid flow.

FIG. 4 is a block diagram of an example microfluidic device with channel expansion that promotes fluid flow.

### DETAILED DESCRIPTION

Microfluidic devices often include channels. Fluid may passively or actively flow from a first channel of a smaller width to a second channel of a greater width. Active fluid flow results when external forces, such as due to microfluidic pumps, assist the flow of fluid. By comparison, passive fluid flow results when no such external forces assist the flow of fluid, and instead capillary and other forces resulting from the interaction of the fluid and the material from which the microfluidic device is fabricated cause the flow of fluid.

When the channels are empty of fluid and instead contain air or other gas, causing fluid to initially flow into the narrower first channel and then from the first channel to and through the wider second channel is referred to as priming. Priming may fail, however. For instance, the initial capillary and other forces may be insufficient for the fluid to flow much past the inlet of the second channel, which is a phenomenon referred to as pinning. Even if pinning does not occur, the flow of fluid through the second channel may be incomplete. Specifically, the fluid may trap air or other gas pockets at sidewalls of the second channel.

A microfluidic device is described herein that ameliorates these and other issues that can occur during priming. The microfluidic device includes a first channel having a first width and a second channel having a second width greater than the first width. The microfluidic device includes a transition channel having a first end fluidically connected to the first channel and a second end fluidically connected to the second channel. The transition channel expands in width from the first width to the second width so as to promote fluid flow from the first channel to the second channel. As such, priming can properly occur without fluidic pinning or the trapping of air or other gas pockets at channel sidewalls.

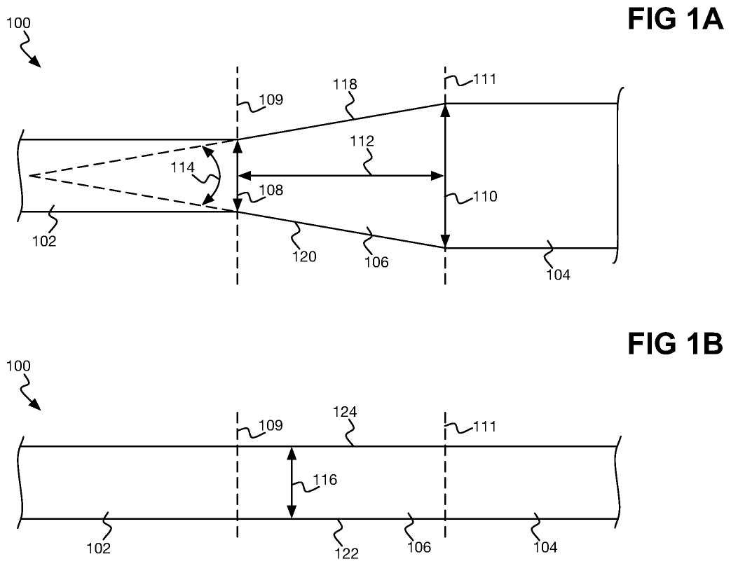

FIGS. 1A and 1B show cross-sectional top and front views, respectively, of an example microfluidic device 100. The microfluidic device 100 includes a first channel 102 having a width 108 and a second channel 104 having a width 110 that is greater than the width 108. The microfluidic device 100 includes a transition channel 106 having a first end 109 fluidically connected to the first channel 102 and a second end 111 fluidically connected to the second channel 104.

The transition channel 106 is thus a channel that transitions the first channel 102 to the second channel 104. The transition channel 106 has sidewalls 118 and 120, a floor 122, and a ceiling 124. The length 112 of the transition channel 106 is defined between the ends 109 and 111, and the height 116 of the transition channel 106 is defined between the floor 122 and the ceiling 124. The height 116 of the transition channel 106, the first channel 102, and the second channel 104 is identical.

The transition channel 106 linearly expands in width from the width 108 of the first channel 102 at the first end 109 to the width 110 of the second channel 104 at the second end 111 along the length 112 of the transition channel 106. The expansion in width of the transition channel 106 is linear in that the angle 114 at which the channel 106 expands, or increases, from the width 108 to the width 110 across its length 112 is constant. The angle 114 is specified to promote fluid flow from the first channel 102 to the second channel 104 so that priming can properly occur without fluidic pinning, and so on.

The angle 114 is based on the fluidic contact angle, which is the contact angle of the liquid fluid that is to flow from the first channel 102, through the transition channel 106, and to the second channel 104 during priming. The fluidic contact angle is the angle where a liquid-vapor interface of the fluid meets a solid surface, such as the sidewalls 118 and 120 of the transition channel 106, and can be measured from the solid surface through the fluid. The fluidic contact angle is thus dependent on the material of the sidewalls 118 and 120 (i.e., the material from which the microfluidic device 100 is fabricated) and on the gas (e.g., air) that fluidic priming displaces, in addition to the liquid fluid itself. The fluidic contact angle is also dependent on temperature and pressure.

The angle 114 is specifically no greater than two times the difference between 90 degrees and the fluidic contact angle. For example, for water on SU-8 epoxy negative photoresist, the fluidic contact angle is approximately 80 degrees at room temperature and atmospheric pressure. Therefore, the angle 114 in such an implementation is no greater than 20 degrees. In the example of FIG. 1A, the angle 114 is 20 degrees.

If the width 110 of the second channel 104 is significantly larger than the width 108 of the first channel 102, linear expansion of the transition channel 106 in width at an angle 114 no greater than 20 degrees can result in the channel 106 having a relatively long length 112. The microfluidic device 100 may thus have to be relatively larger than desired, and/or more of the spatial real estate of the microfluidic device 100 may have to be reserved for the transition channel 106 than desired. Therefore, the transition channel 106 may instead non-linearly expand in width from the width 108 to the width 110 across its length 112 in such a way so as to minimize this length 112 of the channel 106, while still promoting fluid flow during priming.

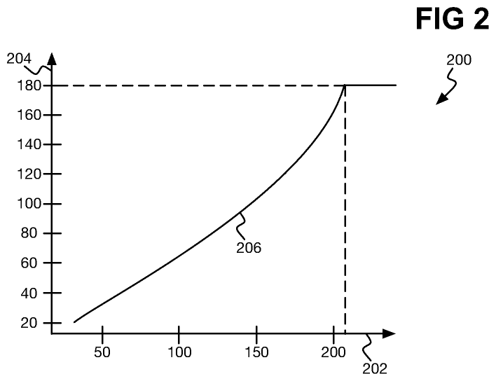

FIG. 2 shows an example graph 200 of the increasing angle at which the transition channel 106 can non-linearly expand in width along its length 112 to promote fluid flow while minimizing the length 112 of the channel 106. The x-axis 202 of the graph 200 denotes the width, in microns, of the transition channel 106, whereas the y-axis 204 of the graph 200 denotes the angle, in degrees, at which the channel 106 is to expand in width. The line 206 of the graph 200 therefore specifies the angle at which the channel 106 is to expand in width at any given width of the channel 106.

Non-linear expansion of the width of the transition channel 106 means that the angle at which the channel 106 expands across its length 112 is variable, and more specifically increases with increasing width. That is, as the transition channel 106 increases in width, the angle at which the channel 106 expands also increases as governed by the line 206. This increasing angle is based (at least) on the fluidic contact. The line 206 in the example of FIG. 2 is specific to the case of a contact angle of 80 degrees, a channel height of 31 microns, and a fluidic surface tension of 70 dynes/centimeter (dyn/cm).

More generally, the transition channel 106 non-linearly expands in width along its length 112 so as to maintain a specified (positive) net capillary fluidic force along the length 112 to promote fluidic flow and thus ensure that priming properly occurs. The net capillary fluidic force is specified per the force balance equation F₀=2γ[w cos θ+h cos(θ+ϕ/2)]. In this equation, F₀ is the net capillary fluidic force, γ is the fluidic surface tension, θ is the fluidic contact angle, ϕ is the increasing angle at which the transition channel 106 non-linearly expands in width, w is the width of the channel 106, and h is the height of the channel 106. The fluidic surface tension γ may depend on the material from which the microfluidic device 100 is fabricated and/or the fluid (i.e., liquid) flowing through the channel 106, as well as other parameters, such as temperature and atmospheric pressure.

The positive first term 2γ[w cos θ] of the net capillary fluidic force F₀ is per the force balance equation contributed by the floor 122 and the ceiling 124 of the transition channel 106 between its sidewalls 118 and 120. This term is thus based on the width w of the channel 106, the fluidic contact angle θ, and the fluidic surface tension γ. More specifically, this term is based on the cosine of the fluidic contact angle θ, multiplied by the width w and two times the fluidic surface tension γ.

The negative second term 2γ[h cos(θ+ϕ/2)] of the net capillary fluidic force F₀ is per the force balance equation contributed by the sidewalls 118 and 120 of the transition channel 106 between its floor 122 and ceiling 124. This term is thus based on the height h of the channel 106, the fluidic contact angle θ, the increasing angle ϕ at which the channel 106 non-linearly expands in width, and the fluidic surface tension γ. More specifically, this term is based on the cosine of the sum of the fluidic contact angle θ and one half of the expansion angle ϕ, multiplied by the width w and two times the fluidic surface tension γ.

The net capillary fluidic force F₀ may be any value greater than zero, and in practice is set to a minimum value, such as 10⁻⁶ Newtons for a transition channel 31 that is 31 microns high and is initially 31 microns wide and in consideration of the surface tension of water. For a specified channel height h, a specified fluidic surface tension γ, and a specified fluidic contact angle θ, the force balance equation is solved beginning at the initial width w of the transition channel 106 (i.e., the width 108) for the angle ϕ at which the channel 106 is to expand, which in turn yields the width w of the transition channel 106 at the next point along its length 112. This process is repeated point-by-point along the length 112 of the transition channel 106 until the width w of the channel 106 becomes equal to the width 110 of the second channel 104, or until the expansion angle ϕ becomes equal to 180 degrees, which occurs at a particular width w greater than 200 microns per the line 206 in the example of FIG. 2.

Solving the force balance equation for the expansion angle ϕ in this manner therefore maintains a constant net capillary fluidic force F₀ along the length 112 of the transition channel 106. Note that as the expansion angle ϕ widens, at some point (e.g., at a particular width w greater than 200 microns per the line 206 in the example of FIG. 2) the expansion angle ϕ reaches 180 degrees, which means the transition channel 106 can then abruptly increase in width w to the width 110 of the second channel 104. Therefore, there is an upper bound to the length 112 of the transition channel 106, regardless of how large the width 110 of the second channel 104 is relative to the width 108 of the first channel 102. That is, solving the force balance equation for the expansion angle ϕ in effect sets the minimum length 112 at which priming can properly occur.

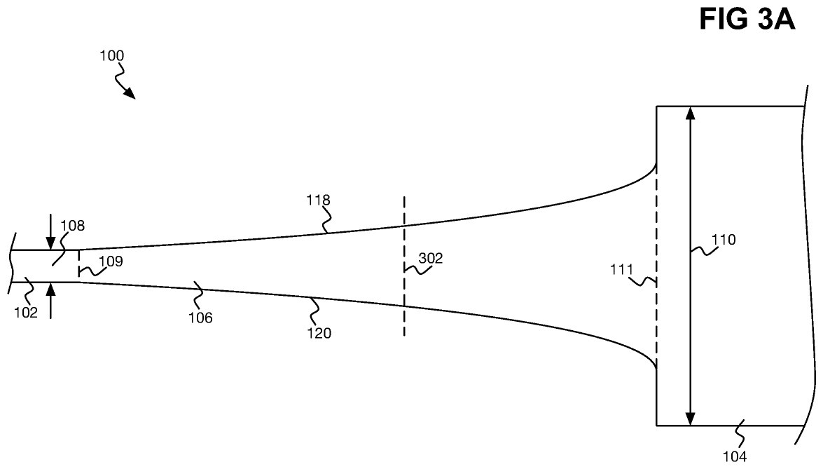

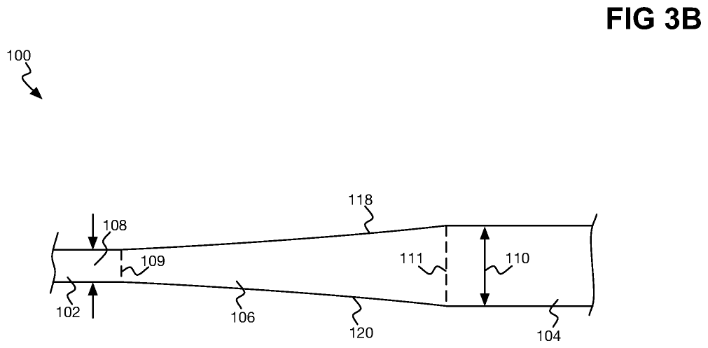

FIGS. 3A and 3B each shows a cross-sectional top view of a different example microfluidic device 100 in which the transition channel 106 non-linearly expands in width along its length 112 in accordance with the described graph 200 of FIG. 2. The microfluidic device 100 again includes the first channel 102 having the width 108 and the second channel 104 having the width 110 that is greater than the width 108. Also as before, the first end 109 of the transition channel 106 of the microfluidic device 100 is fluidically connected to the first channel 102, and the second end 111 of the channel 106 is fluidically connected to the second channel 104.

In both FIGS. 3A and 3B, the transition channel 106 non-linearly expands in width from the width 108 of the first channel 102 at the first end 109 to the width 110 of the second channel 104 at the second end 111 along the length of the transition channel 106. This non-linear expansion in width is governed by the graph 200 of FIG. 2, such that the sidewalls 118 and 120 flare out in a trumpet-like manner at an increasing expansion angle. The expansion angle at any point along the length of the transition channel 106 is the angle between lines tangential to the sidewalls 118 and 120 of the channel 106. The length of the transition channel 106 in both FIGS. 3A and 3B is the minimum such length at which priming can properly occur, such as under the constraints encompassed by the graph 200.

In FIG. 3A, the width 110 of the second channel 104 is much larger than the width 108 of the first channel 102. Therefore, the transition channel 106 can abruptly increase in width at the second end 111 to the width 110 of the second channel 104. That is, at the second end 111, the expansion angle of the transition channel 106 becomes 180 degrees per the graph 200 of FIG. 2, such that the length of the channel 106 in FIG. 3A is at its upper bound per the graph 200. By comparison, in FIG. 3B, the width 110 of the second channel 104 is not significantly larger than the width 108 of the first channel 102. Therefore, the transition channel 106 reaches the width 110 of the second channel 104 at the second end 111 at an expansion angle less than 180 degrees. For sake of illustrative comparison, the second end 111 of the transition channel in FIG. 3B is identified by the dotted line 302 in FIG. 3A.

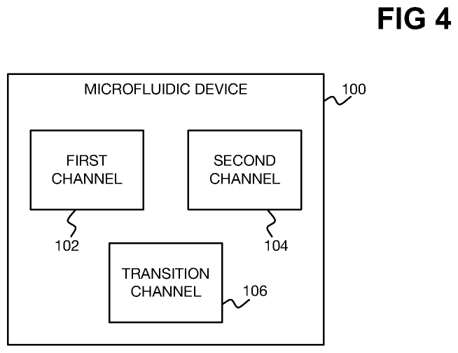

FIG. 4 shows a block diagram of the example microfluidic device 100. The microfluidic device 100 includes a first channel 102 having a first width, a second channel 104 having a second width greater than the first width, and a transition channel 106 having first and second ends fluidically connected to the first and second channels 102 and 104, respectively. The transition channel 106 expands in width from the first width to the second width so as to promote fluid flow from the first channel 102 to the second channel 104. For example, the transition channel 106 may linearly expand in width at an angle no greater than two times a difference between 90 degrees and a fluidic contact angle. As another example, the transition channel 106 may non-linearly expand in width at an increasing angle that maintains a specified positive net capillary fluidic force along a length of the channel 106.

Techniques have been described for promoting fluid flow from a narrower first channel of a microfluidic device to a wider second channel of the device to permit priming to properly occur. Specifically, a transition channel is fluidically connected between the first and second channels, which increases in width from the width of the first channel to the width of the second channel across the length of the transition channel. Such expansion can occur linearly or non-linearly, the former according to a particularly specified expansion angle and the latter according to an increasing expansion angle that maintains a specified positive net capillary fluidic force across the length of the transition channel.

1. A microfluidic device comprising:
a first channel having a first width;
a second channel having a second width greater than the first width; and
a transition channel having a first end fluidically connected to the first channel and a second end fluidically connected to the second channel,
wherein the transition channel expands in width from the first width to the second width so as to promote fluid flow from the first channel to the second channel.

2. The microfluidic device of claim 1, wherein the transition channel linearly expands in width from the first width to the second width at an angle no greater than two times a difference between 90 degrees and a fluidic contact angle.

3. The microfluidic device of claim 2, wherein the angle is no greater than 20 degrees.

4. The microfluidic device of claim 1, wherein the transition channel non-linearly expands in width from the first width to the second width at an increasing angle based on a fluidic contact angle.

5. The microfluidic device of claim 4, wherein the increasing angle maintains a specified positive net capillary fluidic force along a length of the transition channel.

6. The microfluidic device of claim 5, wherein the increasing angle minimizes the length of the transition channel along which the transition channel expands in width from the first width to the second width.

7. The microfluidic device of claim 5, wherein the specified positive net capillary fluidic force is based on a positive first term contributed by a floor and a ceiling of the transition channel between sidewalls of the transition channel and a negative second term contributed by the sidewalls of the transition channel between the floor and the ceiling of the transition channel.

8. The microfluidic device of claim 7, wherein the positive first term and the negative second term are each further based on fluidic surface tension.

9. The microfluidic device of claim 5, wherein the specified positive net capillary fluidic force is based on a positive first term and a negative second term,
wherein the positive first term is based on a width of the transition channel and the fluidic contact angle,
and wherein the negative second term is based on a height of the transition channel, the fluidic contact angle, and the increasing angle at which the transition channel non-linearly expands in width from the first width to the second width.

10. The microfluidic device of claim 9, wherein the positive first term is based on a cosine of the fluidic contact angle,
wherein the negative second term is based on a cosine of a sum of the fluidic contact angle and one half of the increasing angle at which the transition channel non-linearly expands in width from the first width to the second width,
and wherein the positive first term and the negative second term are each further based on fluidic surface tension.

11. The microfluidic device of claim 5, wherein the specified positive net capillary fluidic force is equal to 2γ[w cos θ+h cos(θ+ϕ/2)], wherein γ is fluidic surface tension, θ is the fluidic contact angle, ϕ is the increasing angle at which the transition channel non-linearly expands in width from the first width to the second width, w is a width of the transition channel, and h is a height of the transition channel.

12. A microfluidic device comprising:
a first channel having a first width;
a second channel having a second width greater than the first width; and
a transition channel having a first end fluidically connected to the first channel and a second end fluidically connected to the second channel,
wherein the transition channel linearly expands in width from the first width to the second width at an angle no greater than two times a difference between 90 degrees and a fluidic contact angle.

13. The microfluidic device of claim 12, wherein the angle is no greater than 20 degrees.

14. A microfluidic device comprising:
a first channel having a first width;
a second channel having a second width greater than the first width; and
a transition channel having a first end fluidically connected to the first channel and a second end fluidically connected to the second channel,
wherein the transition channel non-linearly expands in width from the first width to the second width at an increasing angle that maintains a specified positive net capillary fluidic force along a length of the transition channel.

15. The microfluidic device of claim 0, wherein the specified positive net capillary fluidic force is equal to 2γ[w cos θ+h cos(θ+ϕ/2)], wherein γ is the fluidic surface tension, θ is a fluidic contact angle, ϕ is the increasing angle at which the transition channel non-linearly expands in width from the first width to the second width, w is a width of the transition channel, and h is a height of the transition channel.
